(19) United States
(12) Patent Application Publication
(10) Pub. No.: US 2025/0269940 A1
(43) Pub. Date: Aug. 28, 2025

(54) FLOATING WIND POWER GENERATION PLATFORM AND FLOATING WIND POWER GENERATION SYSTEM

(71) Applicant: BITMAIN TECHNOLOGIES INC., Beijing (CN)

(72) Inventors: Qiwei BAI, Beijing (CN); Hongbo ZENG, Beijing (CN); Mingliang HAO, Beijing (CN); Cheng LI, Beijing (CN); Guo WU, Beijing (CN)

(21) Appl. No.: 19/072,893

(22) Filed: Mar. 6, 2025

Related U.S. Application Data
(63) Continuation of application No. PCT/CN2023/115557, filed on Aug. 29, 2023.

(30) Foreign Application Priority Data
Sep. 6, 2022 (CN) 202222368671.6

(51) Int. Cl. B63B 35/44; F03D 13/25

(52) U.S. Cl. CPC B63B 35/4406; F03D 13/256; B63B 2035/446

(57) ABSTRACT

The present application discloses a floating wind power generation platform and a floating wind power generation system. The floating wind power generation platform includes a plurality of hulls and at least one transverse connection structure; where the plurality of hulls are spaced apart along a horizontal direction, two ends of each transverse connection structure are connected to two adjacent hulls respectively, a support frame extends upwards from the top of each hull, adjacent support frames are symmetrically provided in directions away from their respective centers of gravity, and the support frame has an installation position for installation of a wind turbine.

The present application claims priority to Chinese utility model patent application No. CN202222368671.6, entitled “FLOATING WIND POWER GENERATION PLATFORM AND FLOATING WIND POWER GENERATION SYSTEM” and filed to the China National Intellectual Property Administration on Sep. 6, 2022, which is hereby incorporated by reference in its entirety.

### TECHNICAL FIELD

The present application relates to the field of wind power generation, in particular, to a floating wind power generation platform and a floating wind power generation system.

### BACKGROUND

In recent years, in the process of human development and utilization of renewable energy-wind energy, wind turbines have gradually shifted from onshore to shallow-water offshore, and then gradually shifted from shallow-water offshore to deep-water offshore. During this process, various types of offshore floating wind turbine foundations have emerged, such as single-column type (SPAR type), three-column type (semi-submersible type), tension-leg type (TLP), and barge type (Barge). Where usually only basic functions of carrying wind turbines for power generation and transmission are considered for floating foundations in single-column type, three-column type, etc., so deck spaces on such foundations are very small, and therefore a large number of devices cannot be placed on the foundations.

In addition, most of the current offshore floating wind turbine foundations adopt multi-point distributed mooring, which usually only carries a single wind turbine. This type of foundations has low power generation efficiency, and they are affected by the factor of variable offshore wind field and need a yaw system on the wind turbine to complete wind alignment operation in order to achieve maximum power generation efficiency. Based on this, in order to improve power generation efficiency, the following two approaches can usually be considered:

(1) carrying a plurality of wind turbines on a floating foundation, but in a case of yawing for wind alignment, it is easy to encounter a situation where rotors are positioned one in front and one in back along the direction of facing the wind, and the wind turbine in front will greatly affect the power generation efficiency of the wind turbine in back;

(2) increasing a distance between rotor faces, but it will result in a significant increase in the main size of the wind turbine foundation.

Both of the above approaches will have the problem of low power generation efficiency.

### SUMMARY

The first purpose of the present application is to provide a floating wind power generation platform, which aims to solve the technical problem of low power generation efficiency of an offshore floating wind power generation platform.

To achieve the above purpose, the present application provides the following solutions.

A floating wind power generation platform is provided, including at least two hulls, at least one transverse connection structure, and at least two support frames for carrying wind turbines; where the at least two hulls are spaced apart along a horizontal direction, two ends of each transverse connection structure are connected to two adjacent hulls respectively, each support frame extends upwards from the top of each hull, adjacent support frames are symmetrically inclined in directions away from their respective centers of gravity, and the support frame has an installation position for installation of one wind turbine.

The second purpose of the present application is to provide a floating wind power generation system, including at least two wind turbines and the floating wind power generation platform described above; each installation position is installed with one wind turbine.

For the floating wind power generation platform and floating wind power generation system provided in embodiments of the present application, at least two hulls are provided, the hulls are connected together through a transverse connection structure, a support frame for carrying a wind turbine is provided on the top of each hull, so that the floating wind power generation platform can carry at least two wind turbines, effectively improving the power generation efficiency of the floating wind power generation platform. Since the wind turbines are spaced apart from each other along the horizontal direction, and adjacent support frames for installation of the wind turbines are symmetrically inclined in directions away from their respective centers of gravity and extend upwards, the mutual influence between the wind turbines can be reduced during wind power generation.

### BRIEF DESCRIPTION OF DRAWINGS

To describe the technical solutions in embodiments of the present application or in the prior art more clearly, the following briefly introduces the accompanying drawings needed for describing the embodiments or the prior art. Apparently, the accompanying drawings in the following description illustrate merely some embodiments of the present application, and persons of ordinary skill in the art may still derive other drawings from these accompanying drawings without creative effort.

FIG. 1 is a schematic structural diagram of a floating wind power generation platform provided in Example 1 of the present application.

FIG. 2 is an enlarged schematic structural diagram of part a in FIG. 1.

FIG. 3 is an enlarged schematic structural diagram of part b in FIG. 1.

FIG. 4 is an enlarged schematic structural diagram of part c in FIG. 1.

FIG. 5 is a schematic diagram of a first partial structure of a floating wind power generation platform provided in Example 1 of the present application.

FIG. 6 is a schematic diagram of a second partial structure of a floating wind power generation platform provided in Example 1 of the present application.

FIG. 7 is a schematic structural diagram of a floating wind power generation system provided in Example 1 of the present application.

FIG. 8 is a schematic structural diagram of a floating wind power generation platform provided in Example 2 of the present application.

FIG. 9 is a schematic structural diagram of a hull provided in Example 2 of the present application.

### DESCRIPTION OF REFERENCE NUMBERS

10, floating wind power generation system; 20, wind turbine; 21, first wind turbine; 22, second wind turbine; 100, floating wind power generation platform; 110, hull; 111, first hull; 1111, first deck; 1112, first support body; 1113, first floating body; 112, second hull; 1121, second deck; 1122, second support body; 1123, second floating body; 113, deck; 114, support body; 115, floating body; 116, first connecting beam; 117, second connecting beam; 118, inner deck; 120, transverse connection structure; 121, first connecting rod; 122, second connecting rod; 123, third connecting rod; 124, transverse connecting rod; 130, support frame; 131, first support frame; 1311, first installation portion; 1312, first support post; 132, second support frame; 1321, second installation portion; 1322, second support post; 140, installation position; 150, positioning portion; 160, boss.

### DESCRIPTION OF EMBODIMENTS

The technical solutions in the embodiments of the present application will be described clearly and completely in the following with reference to the accompanying drawings in the embodiments of the present application. Apparently, the described embodiments are merely a part rather than all embodiments of the present application. All other embodiments obtained by persons of ordinary skill in the art based on embodiments of the present application without creative effort shall fall within the protection scope of the present application.

It should be noted that all directional indications (such as up, down, left, right, front, back, etc.) in the embodiments of the present application are only used to explain the relative position relationship and movement of respective components in a specific posture, if the specific posture changes, the directional indication will also change accordingly.

It should also be noted that when a component is referred to as “fixed” or “disposed” on another component, it can be directly on the other component or there may be an intermediate component present at the same time. When a component is referred to as “connected to” another component, it can be directly connected to another component or indirectly connected to another component through an intermediate component.

In addition, the descriptions of “first”, “second”, etc. in the present application are for descriptive purposes only and cannot be understood as indicating or implying their relative importance or implying the number of technical features indicated. Therefore, the features defined as “first” and “second” can explicitly or implicitly include at least one of these features. In addition, the technical solutions between various embodiments can be combined with each other, but must be based on the fact that those of ordinary skilled in the art is able to implement them. When the combination of technical solutions is contradictory or impossible to implement, it should be considered that this combination of technical solutions does not exist and is not within the protection scope required by the present application.

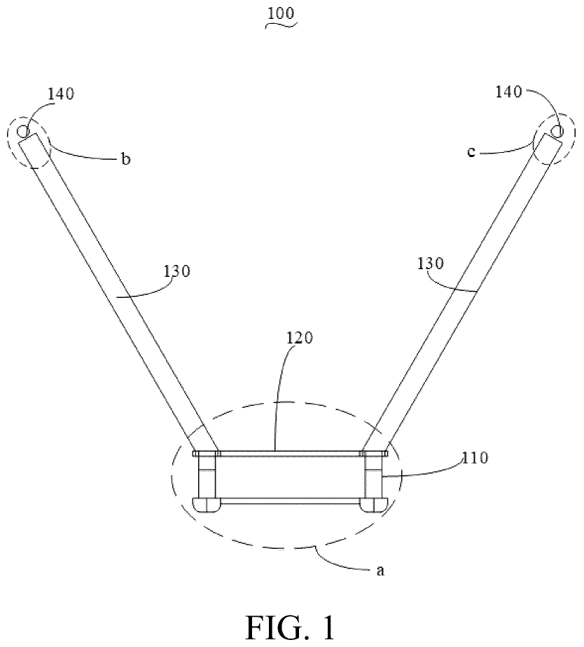

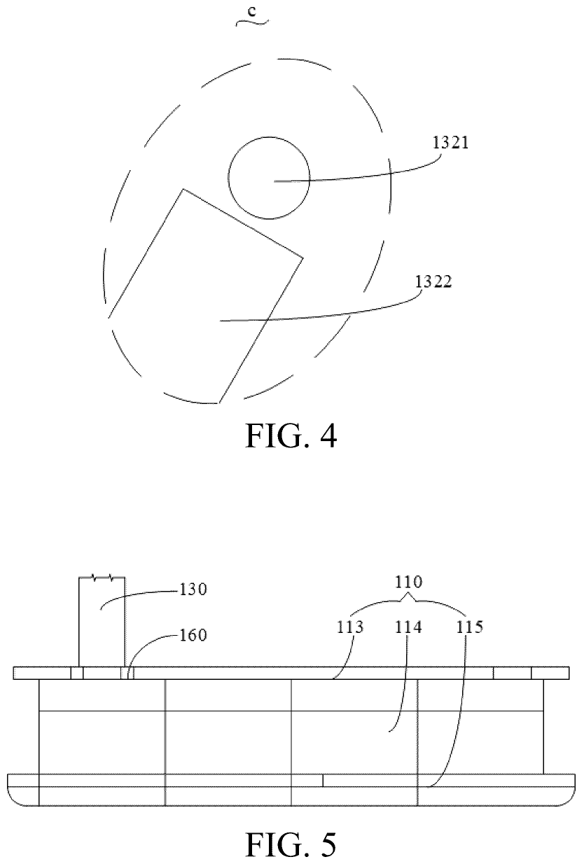

As shown in FIGS. 1 to 9, the floating wind power generation platform 100 provided in this embodiment can be applied to an offshore floating wind power generation system 10, and the floating wind power generation platform 100 can carry a plurality of wind turbines 20 to improve wind power generation efficiency.

### Embodiment 1

A floating wind power generation platform 100 provided in this embodiment can refer to FIGS. 1 to 7.

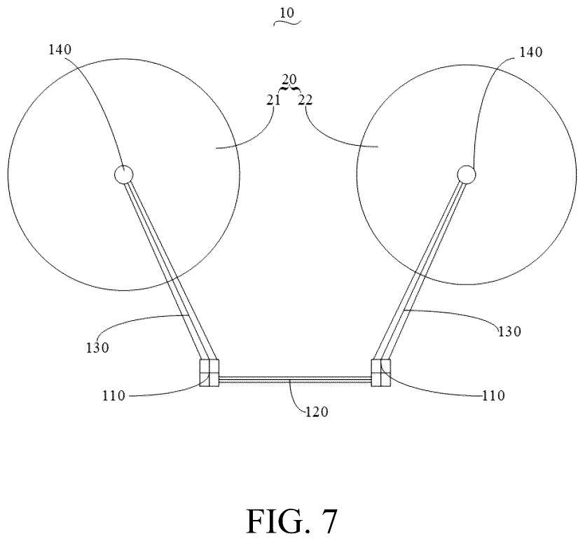

Please refer to FIGS. 1 and 7. The floating wind power generation platform 100 includes hulls 110, a transverse connection structure 120, and support frames 130 for carrying wind turbines 20. At least two hulls 110 and at least two support frames 130 are provided, the hulls 110 and the support frames 130 are in one-to-one correspondence; for example, two, three, or four hulls 110 and support frames 130 are provided respectively. Correspondingly, two, three, or four wind turbines 20 can be carried. A plurality of hulls 110 are spaced apart along a horizontal direction. Adjacent two hulls 110 are connected through the transverse connection structure 120 to assemble the plurality of hulls 110 and improve the stability of the hulls 110 floating on the sea. Each support frame 130 extends upwards from the top of each hull 110, adjacent support frames 130 are symmetrically inclined in directions away from their respective centers of gravity, so that the mutual influence between the wind turbines 20 can be attenuated. In addition, each support frame 130 has an installation position 140 for installation of one wind turbine 20, the support frame 130 can support the wind turbine 20.

It can be understood that the floating wind power generation platform 100 provided in the embodiment of the present application includes the hulls 110, the support frames 130, and the transverse connection structure 120, its structure and connection relationship are simple, which is conducive to the assembly and construction of the wind power generation platform. Moreover, the floating wind power generation platform 100 is provided with the plurality of hulls 110, the hulls are connected together through the transverse connection structure 120; the top of each hull 110 is provided with one support frame 130 for carrying one wind turbine 20, so that the floating wind power generation platform 100 can carry a plurality of wind turbines 20, effectively improving the power generation efficiency of the floating wind power generation platform 100. Since the wind turbines 20 are spaced apart from each other along the horizontal direction, and adjacent support frames 130 for installation of the wind turbines 20 are symmetrically inclined in directions away from their respective centers of gravity and extend upwards, the mutual influence between the wind turbines 20 can be reduced during wind power generation, thereby improving the power generation efficiency of the wind turbines 20.

As shown in FIGS. 1 to 4, as an implementation, two hulls 110 are provided, which are a first hull 111 and a second hull 112, respectively, and correspondingly, two support frames 130 are provided, which are a first support frame 131 and a second support frame 132 respectively. The first hull 111 and the second hull 111 are spaced apart along the horizontal direction, and two opposite sides of the first hull 111 and the second hull 111 are connected through the transverse connection structure 120. The first support frame 131 is installed on the top of the first hull 111, and the first support frame 131 has a first installation portion 1311 for installation of the first wind turbine 21; and the second support frame 132 is installed on the top of the second hull 112, and the second support frame 132 has a second installation portion 1321 for installation of the second wind turbine 22. In this way, the construction of the floating wind power generation platform 100 is simpler.

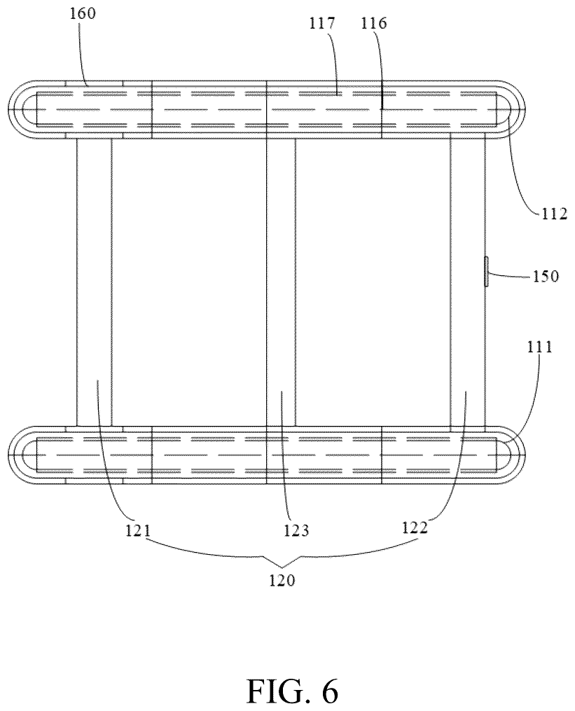

As shown in FIG. 6, as an implementation, the first hull 111 and the second hull 112 are spaced apart and parallel to each other. Or, at least one of the first hull 111 and the second hull 112 extends obliquely from one end towards the other end thereof with respect to the other of the first hull 111 and the second hull 112, with a trend of gradually increasing spacing between the first hull 111 and the second hull 112. This is simple in structure, and improves the smoothness of the first hull 111 and the second hull 112 floating on the sea and improves the stability of the installation of the wind turbines 20. For example, along the direction of the length of the hull, the head end of the first hull 111 and the head end of the second hull 112 are close to each other, so that the first hull 111 and the second hull 112 form an entrainment triangular shape in the horizontal direction.

As shown in FIGS. 1, 5 and 7, as an implementation, the hull 110 includes a deck 113, a support body 114, and a floating body 115. The deck 113 is configured to carry a wind turbine 20 and accommodate related equipment. The support body 114 is configured to connect the deck 113 and the floating body 115, and serve as a waterline plane structure. The floating body 115 provides buoyancy force and bears the structural weight of the support body 114 and the deck 113, as well as the weight of other equipment placed on the hull 110, such as the weight of a ballast system. The deck 113 and the floating body 115 are connected through the support body 114, with a simple structure and a simple connection manner. The deck 113 is located at the top of the support body 114, and the floating body 115 is located at the bottom of the support body 114. At least one of the deck 113, the support body 114 and the deck 113 is connected to an adjacent deck 113, an adjacent support body 114, and an adjacent deck 113 through the transverse connection structure 120, and the support frame 130 is installed on the deck 113.

In this embodiment, with such structural design of the hull 110 that the support frame 130 is carried on the top deck 113 of the hull 110, there is also sufficient deck space on the deck 113 to facilitate the placement of a large amount of equipment and to facilitate the adjustment of the center of gravity of the weight when the floating body 115 is subjected to overall ballast, specifically, the placement position of each equipment can be adjusted to facilitate the adjustment of the center of gravity.

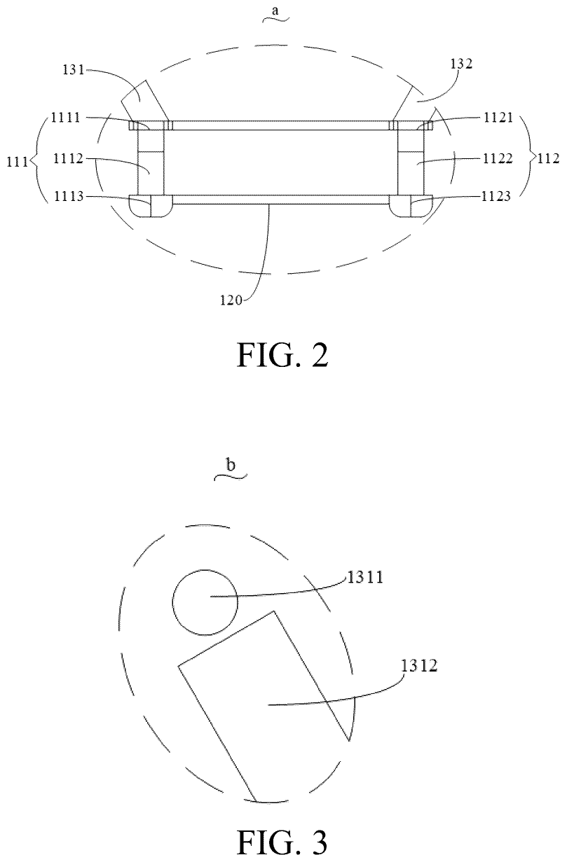

As shown in FIG. 2, exemplarily, the first hull 111 includes a first deck 1111, a first support body 1112, and a first floating body 1113. The first deck 1111 and the first floating body 1113 are connected through the first support body 1112, the first deck 1111 is located at the top of the first support body 1112, and the first floating body 1113 is located at the bottom of the first support body 1112. At least one of the first deck 1111, the first support body 1112, and the first floating body 1113 is connected to the second hull 112 through the transverse connection structure 120. The first support frame 131 is installed on the first deck 1111, and the structure of the first hull 111 is simple, which can reduce the difficulty of manufacturing the first hull 111.

Furthermore, the structure of the second hull 112 is the same as that of the first hull 111, in order to make the structure simpler and make it easier to build the floating wind power generation platform 100. Specifically, the second hull 112 includes a second deck 1121, a second support body 1122, and a second floating body 1123. The second deck 1121 and the second floating body 1123 are connected through the second support body 1122. The second deck 1121 is located at the top of the second support body 1122, the second floating body 1123 is located at the bottom of the second support body 1122, and the second support frame 132 is installed on the second deck 1121.

As shown in FIGS. 1, 2 and 6, as an implementation, the transverse connection structure 120 includes a first connecting rod 121, a second connecting rod 122, and a third connecting rod 123. Two opposite sides of the first deck 1111 and the second deck 1121 are connected through the first connecting rod 121 and the second connecting rod 122 spaced apart along a length direction of the first hull 111, two opposite sides of the first floating body 1113 and the second floating body 1123 are connected through the third connecting rod 123, and the third connecting rod 123 is disposed between and spaced apart from the first connecting rod 121 and the second connecting rod 122 along the length direction of the first hull 111.

It is understandable that the first connecting rod 121 can not only connect and support the first hull 111 and the second hull 112, but also improve the strength of the connection structure between the hull 110 and the bottom of the support frame 130. The first connecting rod 121 can be located on the hull 110 near the support frame 130. The second connecting rod 122 is configured to assist in fixing the first hull 111 and the second hull 112 and enhance their connection stability. The second connecting rod 122 can be located at the head of the hull 110. The third connecting rod 123 is configured to provide tensile and compressive resistance when the double hulls are subjected to transverse wave bending moments and improve the stability of the floating wind power generation platform 100 floating on the sea. The first connecting rod 121, the second connecting rod 122, and the third connecting rod 123 are parallel to each other. It can be seen from side surfaces of the first connecting rod 121, the second connecting rod 122, and the third connecting rod 123 that each of their ends can form a triangle. Overall, the design of the transverse connection structure 120 helps to enhance the structural strength of the hulls 110, thereby improving the safety of offshore operations.

As shown in FIGS. 1 and 5, as an implementation, the hull 110 can adopt a conventional hull to facilitate the design of the length and width of the hull 110 to be wider and longer, and to facilitate increasing the space of the upper end surface of the hull 110 for the placement of some equipment. In addition, the width of the floating body 115 is designed to reduce the area of the waterline plane without affecting the stability of the hull 110. Specifically, the width of the support body 114 is smaller than the width of the floating body 115; and/or, the width of the support body 114 is smaller than the width of the deck 113, this can increase the displacement of the floating body 115, so as to balance the effect of the decrease in the natural period of motion caused by the increase in the principal dimension of the hull 110.

As shown in FIG. 6, as an implementation, a positioning portion 150 is provided on the transverse connection structure 120 for the installation and positioning of a single point mooring apparatus (not labeled), for example, at least one of the first connecting rod 121 or the second connecting rod 122. Specifically, in the embodiment, the positioning portion 150 is provided on the connecting rod 122 to fix the floating wind power generation platform 100 using a single point mooring manner, so that the floating wind power generation platform 100 can automatically align the wind according to the wind direction, thereby ensuring that each wind turbine 20 can generate a large power generation efficiency. Exemplarily, the positioning portion 150 extends from the second connecting rod 122, so that the double hull structure composed of the first hull 111 and the second hull 112 can adaptively yaw and rotate around the single point mooring apparatus, thereby achieving automatic wind alignment function. The positioning portion 150 can be a cantilever beam rigid structure.

As shown in FIGS. 1 and 6, as an implementation, the interior of the hull 110 is provided with several first connecting beams 116 and several second connecting beams 117. The first connecting beams 116 are spaced apart along the length direction of the hull 110, and the second connecting beams 117 are spaced apart along the height direction of the hull 110 and intersectingly connected with the first connecting beams 116. The arrangement of the first connecting beams 116 and the second connecting beams 117 can improve the structural strength and longitudinal stability of the hull 110. The first connecting beams 116 and the second connecting beams 117 can be perpendicular to each other.

As shown in FIGS. 1, 5 and 6, as an implementation, two side walls of the hull 110 extend along the width direction of the hull 110 to form bosses 160. The bosses 160 are configured to cooperate with the hull 110 to support the support frame 130. Specifically, the bosses are formed by the two side walls of the deck 113 near the tail of the hull 110 being extended along the width direction of the hull 110. Specifically, the hull 110 has a first support surface (not labeled) supporting the support frame 130, and the boss 160 has a second support surface (not labeled) connected to the first support surface. The first support surface and the second support surface are both at the same horizontal plane, and together form a support table (not labeled) supporting the support frame 130, in order to improve the stability of the connection between the support frame 130 and the hull 110, thereby enhancing the loading stability of the wind turbine 20.

As shown in FIGS. 1 to 4 and 7, as an implementation, the first support frame 131 includes a first support post 1312 with a first installation portion 1311 formed at the top of the first support post 1312, and the first support post 1312 is installed on the first hull 111. The second support frame 132 includes a second support post 1322 with a second installation portion 1321 formed at the top of the second support post 1322, and the second support post 1322 is installed on the second hull 112. The first support post 1312 and the second support post 1322 extend obliquely upwards with a trend of gradually increasing spacing between them, which can improve the stability of the support frame 130 carrying the wind turbine 20 and enhance the smoothness of the floating wind power generation platform 100 floating on the sea. Moreover, the oblique arrangement of the support frame 130 can make the spacing between the first hull 111 and the second hull 112 reduced, and make the safety space sufficient for meeting the large-sized impeller of the wind turbine 20 in operation status.

### Embodiment 2

Please refer to FIGS. 7 to 9, the difference between the floating wind power generation platform 100 provided in this embodiment and the embodiment 1 mainly lies in the following structural differences:

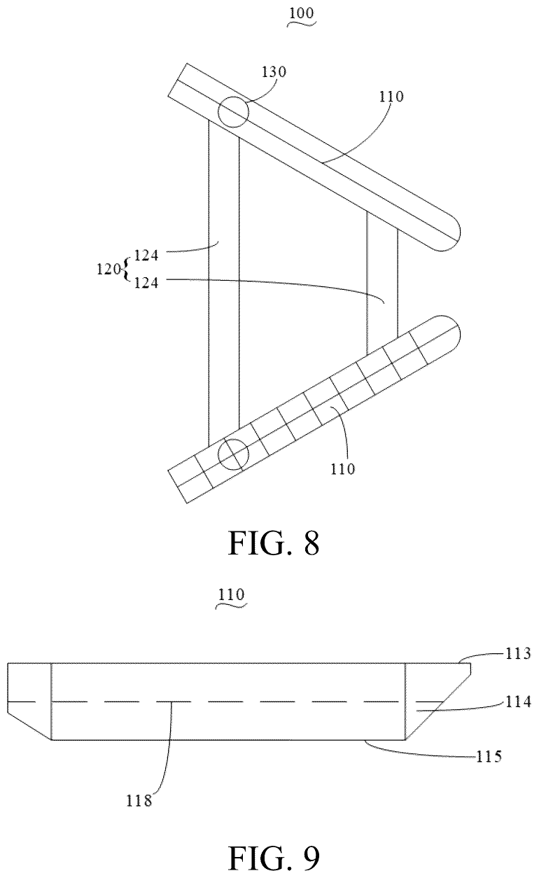

As shown in FIGS. 8 and 9, the design of the width of the deck 113, support body 114 and floating body 115, and the transverse connection structure 120 are different. Specifically, in this embodiment, under the premise of ensuring the overall motion performance and stability of the hull 110, the hull 110 adopts the structure of a small draught hull to support the support frame so as to support the wind turbine 20. Specifically, the widths of the deck 113, support body 114, and floating body 115 gradually smaller. Furthermore, the transverse connection structure 120 includes two transverse connecting rods 124, and two opposite sides of adjacent hulls 110 are connected through the transverse connecting rods 124, making assembling simple.

As shown in FIG. 9, as an implementation, an inner deck 118 is provided inside the hull 110 to enhance the structural strength of the hull 110 and facilitate the separation of compartments of the hull 110.

As shown in FIG. 8, further, one of the two hulls 110 extends obliquely from one end to the other end thereof with respect to the other hull 110 of the two hulls 110, with a trend of gradually increasing spacing between the two hulls 110, the two hulls 110 form a triangular shape having an included angle.

In addition, in this embodiment, the boss 160 may not be provided.

As shown in FIGS. 1 and 7, this embodiment also provides a floating wind power generation system 10, which includes two wind turbines and the floating wind power generation platform 100 of embodiment 1 or embodiment 2; each installation position 140 is installed with one wind turbine.

The above description is only for preferred embodiments of the present application and does not limit the patent scope of the present application. Any equivalent structural transformation made under the application concept of the present application using the content of the specification and drawings of the present application, or direct/indirect application to other related technical fields, are included in the patent protection scope of the present application.

1. A floating wind power generation platform, comprising at least two hulls, at least one transverse connection structure, and at least two support frames for carrying wind turbines, wherein the at least two hulls are spaced apart along a horizontal direction, two ends of each transverse connection structure are connected to two adjacent hulls respectively, each support frame extends upwards from a top of each hull, adjacent support frames are symmetrically inclined in directions away from their respective centers of gravity, and the support frame has an installation position for installation of one wind turbine.

2. The floating wind power generation platform according to claim 1, wherein the hulls comprise a first hull and a second hull, and the support frames comprise a first support frame for carrying a first wind turbine and a second support frame for carrying a second wind turbine; the first hull and the second hull are spaced apart along the horizontal direction, and two opposite sides of the first hull and the second hull are connected through the transverse connection structure;
the first support frame is installed on a top of the first hull, and the first support frame has a first installation portion for installation of the first wind turbine; and
the second support frame is installed on a top of the second hull, and the second support frame has a second installation portion for installation of the second wind turbine.

3. The floating wind power generation platform according to claim 2, wherein the first hull and the second hull are spaced apart and parallel to each other; or, at least one of the first hull and the second hull extends obliquely from one end towards the other end thereof with respect to the other of the first hull and the second hull, with a trend of gradually increasing spacing between the first hull and the second hull.

4. The floating wind power generation platform according to claim 1, wherein each hull comprises a deck, a support body, and a floating body; the deck and the floating body are connected through the support body, the deck is located at a top of the support body, and the floating body is located at a bottom of the support body;
at least one of the deck, the support body and the floating body is connected to an adjacent deck, an adjacent support body, and an adjacent floating body through the transverse connection structure, and the support frame is installed on the deck.

5. The floating wind power generation platform according to claim 4, wherein a width of the support body is smaller than a width of the floating body; or, a width of the support body is smaller than a width of the deck; or, widths of the deck, support body, and floating body gradually smaller.

6. The floating wind power generation platform according to claim 4, wherein the transverse connection structure comprises a first connecting rod, a second connecting rod, and a third connecting rod; two opposite sides of two adjacent decks are connected through the first connecting rod and the second connecting rod spaced apart along a length direction of the hull, two opposite sides of two adjacent floating bodies are connected through the third connecting rod, and the third connecting rod is disposed between and spaced apart from the first connecting rod and the second connecting rod along the length direction of the hull.

7. The floating wind power generation platform according to claim 6, wherein at least one of the first connecting rod and the second connecting rod is provided with a positioning portion, and the positioning portion is configured for installation and positioning of a single point mooring apparatus.

8. The floating wind power generation platform according to claim 1, wherein at least one first connecting beam and at least one second connecting beam are provided inside each hull, the at least one first connecting beam is spaced apart along a length direction of the hull, and the at least one second connecting beam is spaced apart along a height direction of the hull and intersectingly connected with the first connecting beam.

9. The floating wind power generation platform according to claim 1, wherein two side walls of each hull extend to form bosses respectively along a width direction of the hull, and the bosses are configured to cooperate with the hull to support the support frame.

10. A floating wind power generation system, comprising at least two wind turbines and the floating wind power generation platform; each installation position is installed with one wind turbine;
wherein the floating wind power generation platform comprises at least two hulls, at least one transverse connection structure, and at least two support frames for carrying wind turbines, the at least two hulls are spaced apart along a horizontal direction, two ends of each transverse connection structure are connected to two adjacent hulls respectively, each support frame extends upwards from a top of each hull, adjacent support frames are symmetrically inclined in directions away from their respective centers of gravity, and the support frame has an installation position for installation of one wind turbine.

11. The floating wind power generation system according to claim 10, wherein the hulls comprise a first hull and a second hull, and the support frames comprise a first support frame for carrying a first wind turbine and a second support frame for carrying a second wind turbine; the first hull and the second hull are spaced apart along the horizontal direction, and two opposite sides of the first hull and the second hull are connected through the transverse connection structure;
the first support frame is installed on a top of the first hull, and the first support frame has a first installation portion for installation of the first wind turbine; and
the second support frame is installed on a top of the second hull, and the second support frame has a second installation portion for installation of the second wind turbine.

12. The floating wind power generation system according to claim 11, wherein the first hull and the second hull are spaced apart and parallel to each other; or,
at least one of the first hull and the second hull extends obliquely from one end towards the other end thereof with respect to the other of the first hull and the second hull, with a trend of gradually increasing spacing between the first hull and the second hull.

13. The floating wind power generation system according to claim 10, wherein each hull comprises a deck, a support body, and a floating body; the deck and the floating body are connected through the support body, the deck is located at a top of the support body, and the floating body is located at a bottom of the support body;
at least one of the deck, the support body and the floating body is connected to an adjacent deck, an adjacent support body, and an adjacent floating body through the transverse connection structure, and the support frame is installed on the deck.

14. The floating wind power generation system according to claim 13, wherein a width of the support body is smaller than a width of the floating body; or, a width of the support body is smaller than a width of the deck; or, widths of the deck, support body, and floating body gradually smaller.

15. The floating wind power generation system according to claim 13, wherein the transverse connection structure comprises a first connecting rod, a second connecting rod, and a third connecting rod; two opposite sides of two adjacent decks are connected through the first connecting rod and the second connecting rod spaced apart along a length direction of the hull, two opposite sides of two adjacent floating bodies are connected through the third connecting rod, and the third connecting rod is disposed between and spaced apart from the first connecting rod and the second connecting rod along the length direction of the hull.

16. The floating wind power generation system according to claim 14, wherein the transverse connection structure comprises a first connecting rod, a second connecting rod, and a third connecting rod; two opposite sides of two adjacent decks are connected through the first connecting rod and the second connecting rod spaced apart along a length direction of the hull, two opposite sides of two adjacent floating bodies are connected through the third connecting rod, and the third connecting rod is disposed between and spaced apart from the first connecting rod and the second connecting rod along the length direction of the hull.

17. The floating wind power generation system according to claim 15, wherein at least one of the first connecting rod and the second connecting rod is provided with a positioning portion, and the positioning portion is configured for installation and positioning of a single point mooring apparatus.

18. The floating wind power generation system according to claim 10, wherein at least one first connecting beam and at least one second connecting beam are provided inside each hull, the at least one first connecting beam is spaced apart along a length direction of the hull, and the at least one second connecting beam is spaced apart along a height direction of the hull and intersectingly connected with the first connecting beam.

19. The floating wind power generation system according to claim 10, wherein two side walls of each hull extend to form bosses respectively along a width direction of the hull, and the bosses are configured to cooperate with the hull to support the support frame.

20. The floating wind power generation platform according to claim 5, wherein the transverse connection structure comprises a first connecting rod, a second connecting rod, and a third connecting rod; two opposite sides of two adjacent decks are connected through the first connecting rod and the second connecting rod spaced apart along a length direction of the hull, two opposite sides of two adjacent floating bodies are connected through the third connecting rod, and the third connecting rod is disposed between and spaced apart from the first connecting rod and the second connecting rod along the length direction of the hull.
